(19) United States
(12) Patent Application Publication
(10) Pub. No.: US 2021/0151868 A1
(43) Pub. Date: May 20, 2021

(54) ANTENNA MODULE

(71) Applicant: Tamkang University, New Taipei City (TW)

(72) Inventors: Yu-Jen Chi, New Taipei City (TW); I-Nan Lin, New Taipei City (TW); Yi Hu, New Taipei City (TW); Meng-Jey Youh, New Taipei City (TW); Yu-Chuan Wu, New Taipei City (TW)

(73) Assignee: Tamkang University, New Taipei City (TW)

(21) Appl. No.: 16/896,888

(22) Filed: Jun. 9, 2020

(30) Foreign Application Priority Data
Nov. 19, 2019 (TW) 108142031

(51) Int. Cl. H01Q 1/36; H01Q 1/12

(52) U.S. Cl. CPC H01Q 1/36; H01Q 1/12

(57) ABSTRACT

An antenna module includes an antenna and a periodic structure. The periodic structure is disposed on one side of the antenna, and includes a plural first pillars, a plural first bridge members, and a plural second pillars. The plural first pillars are arranged at intervals along a one-dimensional array. The plural first bridge members are arranged at intervals along the one-dimensional array, and are connected to a side of the plural first pillars away from the antenna, wherein the plural first bridge members define a second virtual layer. The plural of second pillars are arranged at intervals in parallel with the first pillars and are connected to a side of the plural first bridge members away from the antenna. Each of the second pillars each of and the first pillars adjacent thereto have an offset from each other in the direction perpendicular to the second virtual layer.

### CROSS-REFERENCE TO RELATED APPLICATION

This non-provisional application claims priority under 35 U.S.C. § 119(a) to Patent Application 108142031 in Taiwan, R.O.C. on Nov. 19, 2019, the entire contents of which are hereby incorporated by reference.

### BACKGROUND

### Technical Field

The instant disclosure relates to an antenna module, and more particularly, to a millimeter wave dielectric electromagnetic band gap (EBG) antenna.

### Related Art

Wireless communication is moving towards requirements for a higher speed and a larger bandwidth. However, the utilization in low and medium frequency bands below 6 GHz has become very crowded. Therefore, the application of millimeter waves of above 28 GHz will become the focus of a future wireless communication technology. However, the accompanying characteristics of the millimeter waves with a high frequency band still make many technical problems to be overcome.

Because the attenuation of high-frequency signals is large, in order to make a transmission distance longer, a plurality of antenna units are required to form an antenna array, so that the directivity of each antenna unit is increased. Traditional antennas often equivalently form a metal surface perpendicular to a circuit board using a plurality of rows of vertical through holes in a multilayer board. The metal surface is used to return electromagnetic waves and focus the antenna in a specific direction. However, in this architecture, the broadband frequency or radiation efficiency of the antenna unit cannot be effectively improved.

Therefore, the inventors of the present disclosure and those working in the technical field of this related industry are eager to improve the issues how to reduce the radiation (diffraction) of the antenna unit in lateral and backward directions to improve the directivity and achieve the best focusing effect, improve the broadband frequency or radiation efficiency of the antenna, and simplify the antenna design.

### SUMMARY

An antenna module includes an antenna and a periodic structure. The periodic structure is disposed on one side of the antenna, and includes a plurality of first pillars, a plurality of first bridge members, and a plurality of second pillars. The antenna is configured to transmit or feed a signal. The plurality of first pillars of the periodic structure are arranged at intervals along a one-dimensional array. The plurality of first bridge members of the periodic structure are arranged at intervals along a one-dimensional array, and are connected to a side of the plurality of first pillars away from the antenna. The plurality of first bridge members define a second virtual layer. The plurality of second pillars of the periodic structure are arranged at intervals along the one-dimensional array, and are connected to a side of the plurality of first bridge members away from the antenna. The plurality of second pillars define a third virtual layer. Each of the second pillars and each of the first pillars adjacent thereto have an offset from each other in the direction perpendicular to the second virtual layer.

As a result, electromagnetic waves of a millimeter-wave frequency cannot pass through the periodic structure, so that the periodic structure may return the electromagnetic waves, reduce the lateral and backward radiation (or diffraction) of the antenna module, improve the directivity of the antenna module, and improve the radiation efficiency of the antenna module.

In some embodiments, the antenna module further includes a plurality of second bridge members, arranged at intervals and connected to a side of the plurality of second pillars away from the antenna. Each of the second bridge members and each of the first bridge members adjacent thereto have an offset from each other in the direction perpendicular to the third virtual layer.

In some embodiments, the first pillars are parallel to each other, the first bridge members are parallel to each other, and the first pillars are perpendicular to the first bridge members.

In some embodiments, there is a distance between the antenna and the periodic structure. The distance is one half to four fifths of a wavelength of the signal.

In some embodiments, intervals between two adjacent first pillars are not exactly the same.

In some embodiments, the intervals are increased or decreased sequentially along the one-dimensional array.

In some embodiments, each of the first bridge members is arc-shaped, and the first bridge member has a corresponding bending angle.

In some embodiments, each of the first bridge members has a middle section and two arc-shaped portions, the two arc-shaped portions have a corresponding bending angle respectively, and the middle section is connected between the two arc-shaped portions.

In some embodiments, the first pillars and the second pillars have similar volumes and shapes respectively.

In some embodiments, the antenna module further includes at least one support arm. Each of the support arms has a connecting end and a coating end opposite to the connecting end. Each of the connecting ends is fixedly connected to the periodic structure. The antenna is coated on each of the coating ends.

In some embodiments, the antenna module further includes two support arms. Each of the support arms has a connecting end and a coating end opposite to the connecting end. The two connecting ends are fixedly connected to the periodic structure. The two coating ends are in contact with each other. The antenna is coated on the two coating ends.

In some embodiments, the antenna module further includes a support housing. The support housing houses the periodic structure. The support housing has a fixed connection surface and an exposed surface. The fixed connection surface is in contact with an end of at least one of the first pillars, an end of at least one of the first bridge members, and an end of at least one of the second pillars. The antenna is coated on the exposed surface.

In some embodiments, the support housing has a thickness that satisfies the following equation:

$$T \leq \frac{1}{N} \times \frac{C}{f \sqrt{{ɛ}_{r}}}$$

“T” represents a thickness of a housing, “C” represents a speed of light, “f” represents a frequency, and “εᵣ” represents a relative dielectric coefficient of a material, “N” being a positive integer between 6 and 12.

In some embodiments, an antenna module includes an antenna and a periodic structure. The periodic structure is disposed on one side of the antenna, and includes a plurality of first bridge members, a plurality of first pillars, and a plurality of second bridge members. The antenna is configured to transmit or feed a signal. The periodic structure is disposed on one side of the antenna, and includes a plurality of first bridge members, a plurality of first pillars, and a plurality of second bridge members. The first bridge members are arranged at intervals along a one-dimensional array. The plurality of first pillars are arranged at intervals along the one-dimensional array, and are connected to a side of the first bridge members away from the antenna. The plurality of first pillars define a second virtual layer. The plurality of second bridge members are arranged at intervals in parallel with the plurality of first bridge members and are connected to a side of the first bridge members away from the antenna. The plurality of second bridge members define a third virtual layer. Each of the second bridge members and each of the first bridge members adjacent thereto the second bridge members have an offset from each other in the direction perpendicular to the second virtual layer.

Detailed features and advantages of the instant disclosure are described in detail in the following implementations, and the content of the implementations is sufficient for a person skilled in the art to understand and implement the technical content of the instant disclosure. A person skilled in the art can easily understand the objectives and advantages related to the instant disclosure according to the contents disclosed in this specification, the claims and the drawings.

### BRIEF DESCRIPTION OF THE DRAWINGS

FIG. 1 is a view of a use state of one implementation pattern of a first embodiment of the instant disclosure;

FIG. 2 is a view of a use state of one implementation pattern of a second embodiment of the instant disclosure;

FIG. 3 is a schematic perspective view of one implementation pattern of a first embodiment of the instant disclosure;

FIG. 4 is a schematic perspective view of one implementation pattern of a first embodiment of the instant disclosure;

FIG. 5 is a relationship graph between a return loss and a frequency response of an antenna module according to the instant disclosure;

FIG. 6 is a relationship graph between a return loss and a frequency response of an antenna module according to the instant disclosure;

FIG. 7 is a schematic perspective view of one implementation pattern of a first embodiment of the instant disclosure;

FIG. 8 is a simulated graph of a radiation pattern of an antenna module on an X-Z plane and a Y-Z plane according to the instant disclosure;

FIG. 9 is a schematic perspective view of one implementation pattern of a second embodiment of the instant disclosure;

FIG. 10 is a schematic perspective view of one implementation pattern of a second embodiment of the instant disclosure;

FIG. 11 is a simulated graph of a radiation pattern of an antenna module on a Y-Z plane according to the instant disclosure;

FIG. 12 is a schematic perspective view of one implementation pattern of a third embodiment of the instant disclosure;

FIG. 13 is a schematic perspective view of one implementation pattern of a fourth embodiment of the instant disclosure;

FIG. 14 is a partial view of part 14 in a second embodiment shown in FIG. 12;

FIG. 15 is a schematic perspective view of one implementation pattern of a first embodiment of the instant disclosure; and

FIG. 16 is a schematic perspective view of one implementation pattern of a second embodiment of the instant disclosure.

### DETAILED DESCRIPTION

Various embodiments are described below in detail. However, these embodiments are only described as examples and are not intended to limit the protection scope of the instant disclosure. Well-known components and steps are not described in the embodiments to avoid unnecessary limitations on the content of the instant disclosure. In addition, some components are omitted in the drawings of the embodiments to clearly show the technical features of the instant disclosure. The same reference numbers are used in the drawings to indicate the same or similar components.

As used herein, “a” and “the” may broadly mean one or more than one unless otherwise particularly defined. It will be further understood that as used herein, the terms such as “comprise” and “include” specify the stated features, regions, integers, steps, operations, elements, and/or components thereof, but do not preclude the presence or addition of one or more other features, regions, integers, steps, operations, elements, components, and/or groups thereof.

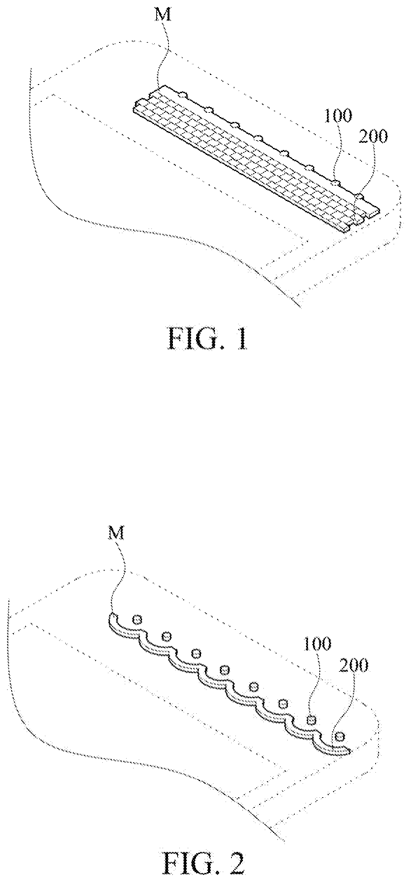

Please refer to FIG. 1 and FIG. 2 at the same time. FIG. 1 is a view of a use state of one implementation pattern of a first embodiment of the instant disclosure. FIG. 2 is a view of a use state of one implementation pattern of a second embodiment of the instant disclosure. As can be seen from FIG. 1 and FIG. 2, an antenna module M of the instant disclosure may be installed inside a communication device. In FIG. 1 and FIG. 2, for example, the antenna module M is disposed on a mobile phone, but the instant disclosure is not limited thereto. The antenna module of the instant disclosure may also be applied to tablet computers, automatic systems, radars, base stations, and the like. The antenna module M of the instant disclosure may be applied to 5th generation mobile networks or 5th generation wireless systems, but the instant disclosure is not limited thereto. The antenna module M may also be applied to communication and non-communication systems of different frequency bands. The detailed structure of the antenna module M will be described next.

### First Embodiment

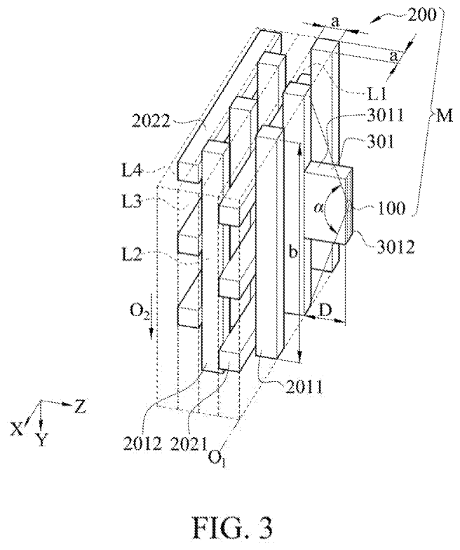

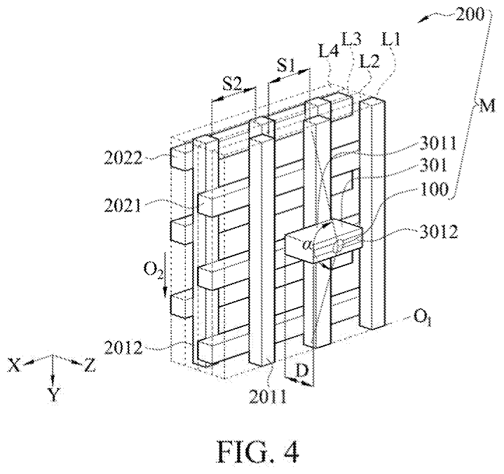

Please refer to FIG. 3 and FIG. 4 at the same time. FIG. 3 is a schematic perspective view of one implementation pattern of a first embodiment of the instant disclosure. FIG. 4 is a schematic perspective view of one implementation pattern of a first embodiment of the instant disclosure. The antenna module M in the present embodiment includes an antenna 100 and a periodic structure 200. The antenna 100 is configured to transmit or feed a signal. The signal particularly refers to a signal in a millimeter wave band, but the instant disclosure is not limited thereto. A side of the periodic structure 200 facing the antenna 100 forms a return region for returning electromagnetic waves. The antenna 100 and an edge of the periodic structure 200 form an angle α, and the angle is less than 45 degrees.

The antenna 100 may be coated with a metal wire through a dispenser and a robot arm, or coated on a surface of the periodic structure 200 by evaporation. The instant disclosure is not limited to the foregoing combination, that is the antenna 100 may also be directly disposed on a printing circuit board. In this embodiment, the antenna 100 is coated on one end of a support arm 301. A connection of the support arm 301 to the periodic structure 200 and the antenna 100 will be further described later.

Please refer to FIG. 3 and FIG. 4 again. The periodic structure 200 is disposed on one side of the antenna, and includes a plurality of first pillars 2011, a plurality of first bridge members 2021, and a plurality of second pillars 2012. The periodic structure 200 should have the characteristics of high dielectric constant and low loss, may be a dielectric non-conductive material, such as a ceramic material (alumina, zirconia, alumina composition, or zirconia composition, etc.), and is manufactured by a ceramic additive manufacturing technology, but the instant disclosure is not limited thereto.

For ease of the description of the present embodiment, an X direction, a Y direction, and a Z direction that are perpendicular to each other are defined. The plurality of first pillars 2011 of the periodic structure 200 are arranged in a straight line at intervals in the direction of a one-dimensional array O1. The first pillars 2011 are parallel to each other. The direction of the one-dimensional array O1 is a straight line parallel to the X direction. There is an interval S1 between adjacent first pillars 2011. Moreover, the plurality of first pillars 2011 define a first virtual layer L1.

Please refer to FIG. 3 and FIG. 4 again. The plurality of first bridge members 2021 of the periodic structure 200 are elongated pillars extending in an arrangement direction of the first pillars 2011. The first bridge members 2021 are parallel to each other. The first bridge members 2021 are arranged at intervals in the direction of a one-dimensional array O2, and are connected to a side of the plurality of first pillars 2011 away from the antenna 100. The direction of the one-dimensional array O2 is parallel to the Y direction. In other words, the direction of the one-dimensional array O2 and the arrangement direction of the first pillars 2011 are two directions perpendicular to each other. The first pillars 2011 are perpendicular to the first bridge members 2021. As can be seen from FIG. 3 and FIG. 4, the first bridge members 2021 and the first pillars 2011 are intersected arranged to form a fence-like structure. In this embodiment, the plurality of first pillars 2021 define a second virtual layer L2.

Please refer to FIG. 3 and FIG. 4 again. The plurality of second pillars 2012 of the periodic structure 200 are arranged in a straight line at intervals in parallel with the first pillars 2011 and are connected to a side of the plurality of first bridge members 2021 away from the antenna 100. There is an interval S2 between adjacent second pillars 2012. In other words, the plurality of second pillars 2012 and the plurality of first pillars 2011 are arranged in a micro-array form. The plurality of second pillars 2012 may define a third virtual layer L3, and the third virtual layer L3 and the second virtual layer L2 are parallel to each other. As can be seen from FIG. 3 and FIG. 4, the first virtual layer L1 defined by the plurality of first pillars 2011, the second virtual layer L2 defined by the plurality of first bridge members 2021, and the third virtual layer L3 defined by the plurality of second pillars 2012 are arranged sequentially from the antenna 100 to the direction away from the antenna.

Please refer to FIG. 3 and FIG. 4 again. Each of the second pillars 2012 and each of the first pillars 2011 adjacent thereto have an offset from each other in the direction perpendicular to the second virtual layer L2. In other words, viewed from the direction of the antenna 100 toward the periodic structure 200, each of the second pillars 2012 does not completely overlap with two first pillars 2011 adjacent to the second pillar 2012.

As can be known from the above, the plurality of first pillars 2011 and the plurality of first bridge members 2021 are intersected to form a fence-like structure, and the plurality of second pillars 2012 and the plurality of first bridge members 2021 are intersected to form a fence-like structure. That is, the plurality of first pillars 2011, the plurality of first bridge members 2021, and the plurality of second pillars 2012 are sequentially stacked, and the pillars (the first pillars 2011 and the second pillars 2012) and the bridge members (the first bridge members 2021) are intersected to each other. The second pillars 2012 and the first pillars 2011 are arranged in a micro-array form and present a mutually offset structure. As a result, electromagnetic waves of a specific frequency cannot pass through the periodic structure 200, so that the periodic structure 200 may return the electromagnetic waves, reduce the lateral and backward radiation (or diffraction) of the antenna module M, improve the directivity of the antenna module M, and improve the radiation efficiency of the antenna module M. The electromagnetic waves of a specific frequency include, but are not limited to, electromagnetic waves of a millimeter-wave frequency, electromagnetic waves of a micron-wave frequency, or other electromagnetic waves of a higher or lower frequency.

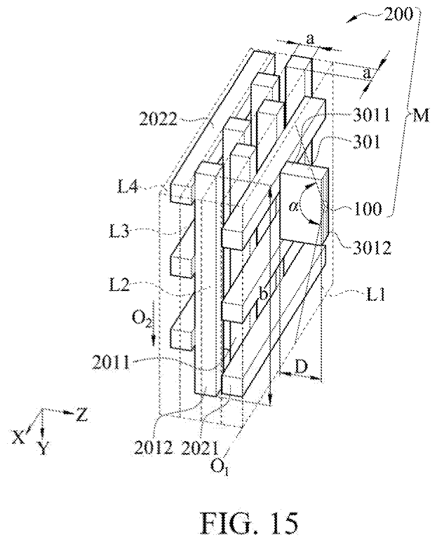

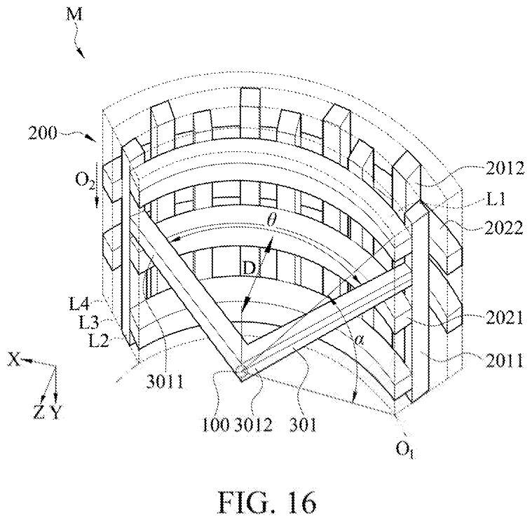

It should be particularly noted that, in this embodiment, the plurality of first pillars 2011, the plurality of first bridge members 2021, the plurality of second pillars 2012, and the plurality of second bridge members 2022 are arranged, not limited to, from the antenna to the direction away from the antenna. Please refer to FIG. 15. FIG. 15 is a schematic perspective view of one implementation pattern of a first embodiment of the instant disclosure. In an implementation pattern of this embodiment, the plurality of first bridge members 2021, the plurality of first pillars 2011, the plurality of second bridge members 2022, and the plurality of second pillars 2012 are arranged sequentially from the antenna to the direction away from the antenna. An arrangement manner of the plurality of first bridge members 2021, an arrangement manner of the plurality of first pillars 2011, an arrangement manner of the second bridge members 2022, and an arrangement manner of the plurality of second pillars 2012 are similar to those described above, and will not be repeated here. The pillars (the first pillars 2011 and the second pillars 2012) are also intersected to the bridge members (the first bridge members 2021). The periodic structure 200 has an effect of returning electromagnetic waves, reduces the lateral and backward radiation (or diffraction) of the antenna module M, improves the directivity of the antenna module M, and improves the radiation efficiency of the antenna module M.

Please refer to FIG. 3 and FIG. 4 again. In this embodiment, the periodic structure 200 may further include a plurality of second bridge members 2022 arranged at intervals in the direction of a one-dimensional array O2, and connected to a side of the plurality of second pillars 2012 away from the antenna 100. The plurality of second bridge members 2022 define a fourth virtual layer L4. That is, the first virtual layer L1 defined by the plurality of first pillars 2011, the second virtual layer L2 defined by the plurality of first bridge members 2021, the third virtual layer L3 defined by the plurality of second pillars 2012, and the fourth virtual layer L4 defined by the plurality of second bridge members 2022 are arranged sequentially from the antenna 100 to the direction away from the antenna.

Each of the second bridge members 2022 and each of the first bridge members 2021 adjacent thereto have an offset from each other in the direction perpendicular to the third virtual layer L3. In other words, viewed from the direction of the antenna 100 toward the periodic structure 200, each of the second bridge members 2022 does not completely overlap with two first bridge members 2021 adjacent to the second bridge member.

It should be particularly noted that, in this embodiment, it is not limited to include only the plurality of first pillars 2011, the plurality of first bridge members 2021, the plurality of second pillars 2012, and the plurality of second bridge members 2022. It is also possible to further arrange a plurality of third pillars and a plurality of third bridge members on a side of the second bridge member 2022 away from the antenna 100 according to actual needs. An implementation pattern of arranging the plurality of third pillars and the plurality of third bridge members is also covered by the present embodiment.

Please refer to FIG. 3 and FIG. 4 again. It should be particularly noted that, in this embodiment, the first pillars 2011 and the second pillars 2012 have similar volumes and shapes respectively. Each of the first pillars 2011 in the periodic structure 200 has a similar length b and thickness a (the length and width of a cross section of the pillar). Each of the second pillars 2012 has a similar length b and thickness a. The first pillars 2011 and the second pillars 2012 have similar length b and thickness a. In other words, all the pillar structures of the periodic structure 200 (whether the first pillars 2011, the second pillars 2012, the third pillars, and so on, without repeating) have similar volumes and shapes. A volume and shape variation ratio of the first and second pillars 2011 and 2012 is not more than 5%. Preferably, the volume and shape variation ratio of the first and second pillars 2011 and 2012 is not more than 2%. By means of the design of maintaining the same volume and shape of each of the first pillars and the second pillars, the radiation penetration of the periodic structure 200 is reduced, so that the radiation efficiency of the antenna module M is improved.

It should be particularly noted that, in this embodiment, in addition to whether the shape and volume of the pillars (the first pillars 2011 and the second pillars 2012) are similar, the thickness and length of the pillars will change the effect of returning electromagnetic waves. A relationship between the length b and thickness a of the pillars will be described below.

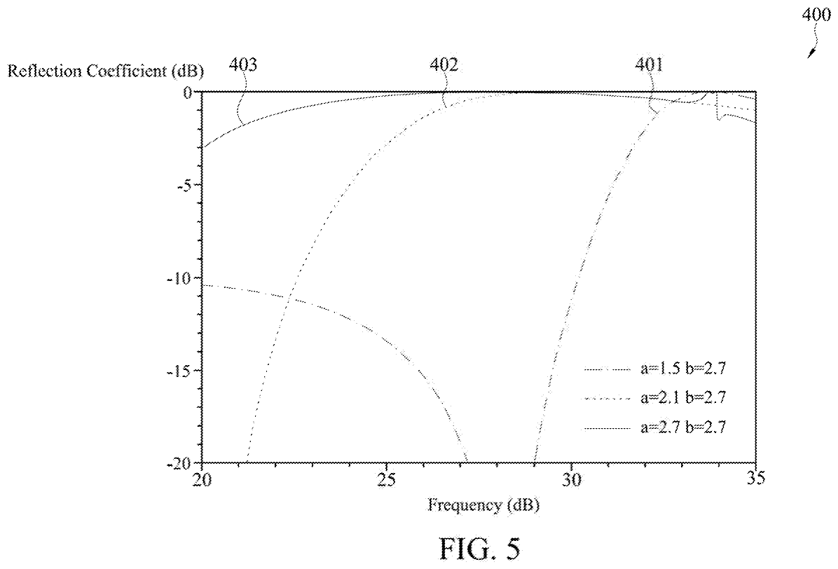

Please refer to FIG. 3 and FIG. 5. FIG. 5 is a relationship graph between a return loss and a frequency response of an antenna module according to the instant disclosure. A relationship graph 400 between a return loss and a frequency response of an antenna module in FIG. 5 includes three curves, which are a curve 401, a curve 402, and a curve 403, respectively. The curve 401 is a return loss at different operating frequencies when the thickness a of the pillars is 1.5 units and the length b is 2.7 units. The curve 402 is a return loss at different operating frequencies when the thickness a of the pillars is 2.1 units and the length b is 2.7 units. The curve 403 is a return loss at different operating frequencies when the thickness a of the pillars is 2.7 units and the length b is 2.7 units. As can be seen from FIG. 5, if the length b is fixed, a smaller thickness a of the pillars has a better return effect in a relatively high frequency band. In the case where the length b is fixed, the thickness a of the pillars has a better return effect in a target working frequency band under a specific size. The unit may be, for example, micron (μm), but the instant disclosure is not limited thereto. Here, electromagnetic waves of a target working frequency band include, but are not limited to, electromagnetic waves of a millimeter-wave frequency, electromagnetic waves of a micron-wave frequency, or other electromagnetic waves of a higher or lower frequency.

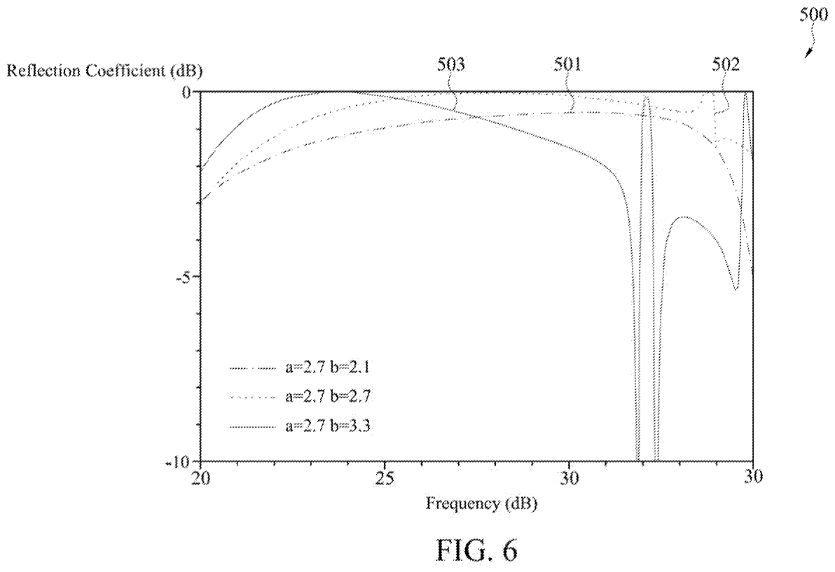

Please refer to FIG. 6. FIG. 6 is a relationship graph between a return loss and a frequency response of an antenna module according to the instant disclosure. A relationship graph 500 between a return loss and a frequency response of an antenna module in FIG. 6 includes three curves, which are a curve 501, a curve 502, and a curve 503, respectively. The curve 501 is a return loss at different operating frequencies when the thickness a of the pillars is 2.7 units and the length b is 1.5 units. The curve 502 is a return loss at different operating frequencies when the thickness a of the pillars is 2.7 units and the length b is 2.1 units. The curve 503 is a return loss at different operating frequencies when the thickness a of the pillars is 2.7 units and the length b is 3.1 units. As can be seen from FIG. 6, if the thickness a of the pillars is fixed, the length b of the pillars has a better return characteristic in a target working frequency band under a specific size. The unit may be, for example, micron (μm), but the instant disclosure is not limited thereto. Electromagnetic waves of a target working frequency band include, but are not limited to, electromagnetic waves of a millimeter-wave frequency, electromagnetic waves of a micron-wave frequency, or other electromagnetic waves of a higher or lower frequency.

Please refer to FIGS. 3 to 4 again. In one implementation pattern of this embodiment, the interval S1 between two adjacent first pillars 2011 is the same. However, the instant disclosure is not limited thereto. In one implementation pattern of this embodiment, the interval S1 between two adjacent first pillars 2011 may be not exactly the same. For example, the interval S1 may be increased or decreased sequentially in an arrangement direction of the first pillars 2011. It should be noted that when the intervals S1 are not exactly the same, a width variation ratio of two adjacent intervals S1 is not greater than 5%. For example, when the width of one of the intervals S1 is 2 mm, the width of an interval S1 adjacent thereto is between 1.9 mm and 2.1 mm. This illustration does not limit practical implementation patterns of the instant disclosure.

In this embodiment, the design of the interval S2 between two adjacent second pillars 2012 and the design of the interval S1 between two adjacent first pillars 2011 adopt the similar rule. For example, the interval S2 between two adjacent second pillars 2012 may be exactly the same or may be not exactly the same. For example, the interval S2 may be increased or decreased sequentially in an arrangement direction of the second pillars 2012. It should be noted that when the intervals S2 are not exactly the same, a width variation ratio of two adjacent intervals S2 is not greater than 5%.

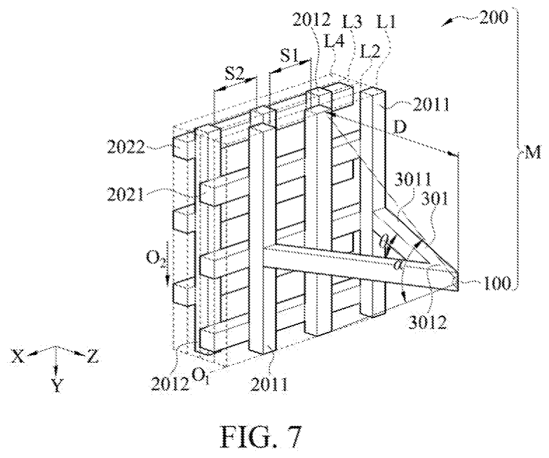

Please refer to FIG. 3 to FIG. 4 and FIG. 7. FIG. 7 is a schematic perspective view of one implementation pattern of a first embodiment of the instant disclosure. In this embodiment, the antenna module M further includes at least one support arm 301, for example, one support arm 301, two support arms 301, or three support arms 301, but the instant disclosure is not limited thereto. The quantity may be adjusted by users according to actual needs.

Please refer to FIGS. 3 and 4. FIGS. 3 and 4 are implementation patterns of one support arm 301 included in a first embodiment of the instant disclosure. The support arm 301 has a connecting end 3011 and a coating end 3012 opposite to the connecting end 3011. Each of the connecting ends 3011 is fixedly connected to the periodic structure 200. The antenna 100 is coated on each of the coating ends 3012.

Please refer to FIG. 7. FIG. 7 is an implementation pattern of two support arms 301 included in a first embodiment of the instant disclosure. In detail, each of the support arms 301 has a connecting end 3011 and a coating end 3012 opposite to the connecting end. The two connecting ends 3011 are fixedly connected to the periodic structure 200. The two coating ends 3012 are in contact with each other. The antenna 100 is coated on the two coating ends 3012.

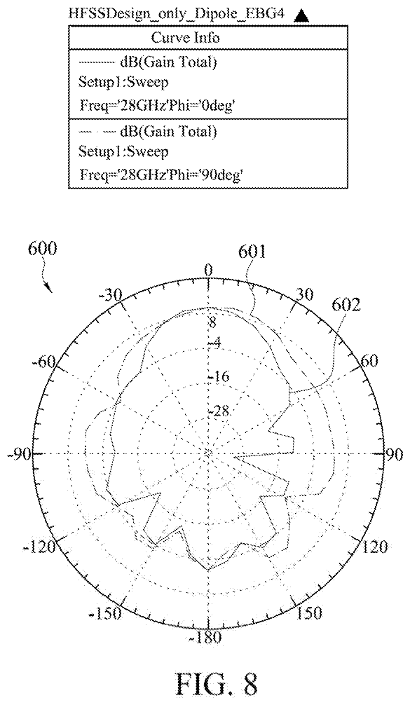

Please refer to FIG. 3 and FIG. 8. FIG. 8 is a simulated graph of a radiation pattern of an antenna module on an X-Z plane and a Y-Z plane according to the instant disclosure. In this embodiment, there is a distance D between the antenna 100 and the periodic structure 200. In this embodiment, the distance D is the shortest distance from the periodic structure 200 to the antenna 100. The distance D is related to a dielectric constant of a material and may be one half to four fifths of a wavelength of a signal, such as one half, two thirds, three fourths or four fifths. In this embodiment, the optimal distance D is three fourths of the wavelength of the signal, but the instant disclosure is not limited thereto. FIG. 8 is a simulated graph 600 of a radiation pattern of an antenna module M operating at 28 GHz in a first embodiment. A curve 601 represents an antenna gain magnitude at every angle on a YZ plane. A curve 602 represents an antenna gain magnitude at every angle on an XZ plane. As can be seen from FIG. 8, when the antenna 100 is placed in front of the periodic structure 200 at a distance D of 8 mm, that is, when the distance D is one half of the wavelength of the signal, it may have the best directivity and lower backward radiation, so that the antenna radiates in a positive Z direction as shown in FIGS. 3, 4, and 7.

### Second Embodiment

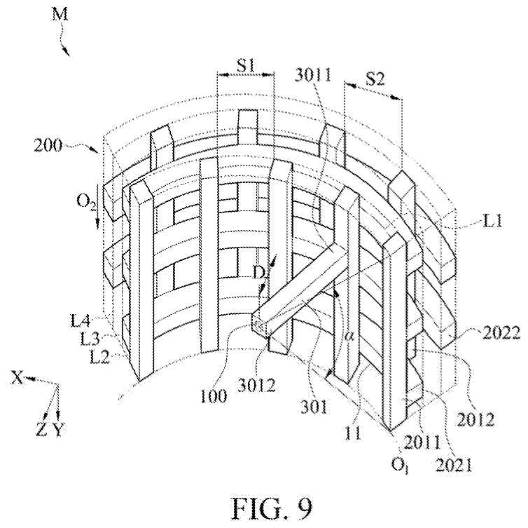

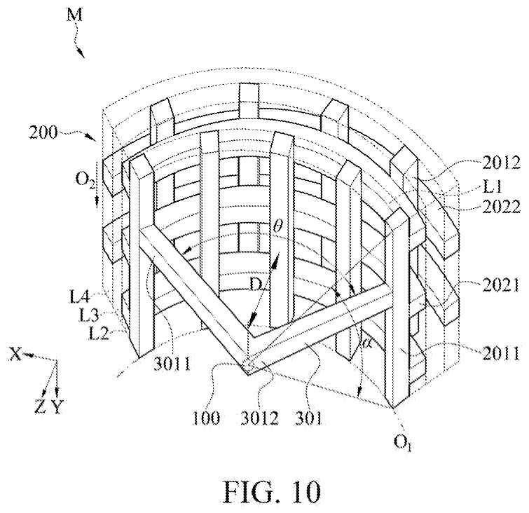

Please refer to FIG. 9, FIG. 10, and FIG. 16. FIG. 9 is a schematic perspective view of one implementation pattern of a second embodiment of the instant disclosure. FIG. 10 is a schematic perspective view of one implementation pattern of a second embodiment of the instant disclosure. FIG. 16 is a schematic perspective view of one implementation pattern of a second embodiment of the instant disclosure. The similarities to the first embodiment in this embodiment will be marked with the same component symbols and will not be repeated again.

The present embodiment is different from the first embodiment in that the plurality of first pillars 2011 in the first embodiment are arranged in a straight line at intervals in the direction of the one-dimensional array O1. In the present embodiment, the one-dimensional array O1 of the plurality of first pillars 2011 are arranged in an arc-line, that is, the plurality of first pillars 2011 in the present embodiment are not arranged in a straight line.

The first bridge members 2021 are elongated pillars extending in an arrangement direction of the first pillars 2011, that is the first bridge members 2021 are in an arc-shaped, and the first bridge members 2021 have a corresponding bending angle θ. That is, the length of the arc-shaped first bridge members 2021 is defined as a predetermined arc length. The predetermined arc length has a corresponding bending angle θ (degree).

Please refer to FIG. 9 and FIG. 10 again. In this embodiment, there is a distance D between the antenna 100 and the periodic structure 200. In this embodiment, the distance D is the shortest distance from the periodic structure 200 to the antenna 100.

In an implementation pattern of this embodiment, the bending angle θ is related to a dielectric constant of a material for manufacturing the periodic structure 200 and the type of an excitation source. For example, the dielectric constant of the periodic structure 200 suitable for a millimeter wave band may be between 6 and 40. The excitation source may be a monopole antenna, a dipole antenna, a slot antenna, a microstrip antenna, and the like. In this implementation pattern, the bending angle θ is between 0 and 150 degrees, preferably between 60 and 110 degrees, and more preferably between 80 and 100 degrees. The angle (unit: degree) is a result of dividing the length of an arc which is cut out on a circle by the circumference of the circle and multiplying by 360.

In this embodiment, the bending angle θ of the periodic structure 200 is 90 degrees. The distance D between the antenna 100 and the periodic structure 200 is one half of the wavelength, which has the best directivity and lower backward radiation. It should be noted that, in an implementation pattern of this embodiment, the antenna 100 may be a dipole antenna.

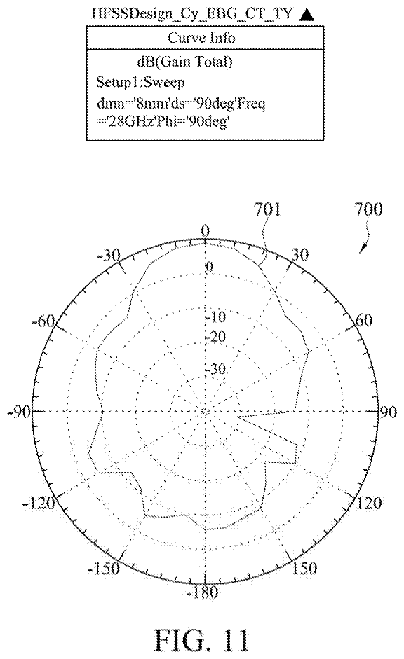

Please refer to FIG. 11, which is a simulated graph of a radiation pattern of an antenna module on a Y-Z plane according to the instant disclosure. FIG. 11 is a simulated diagram 700 of a radiation pattern of an antenna module M operating at 28 GHz in a second embodiment. For example, when the angle is 0, it indicates that a radiation amount in the Z direction of the antenna module M marked in FIG. 9 and FIG. 10 is measured. The curve 701 represents an antenna gain magnitude at every angle on the YZ plane. As can be seen from FIG. 11, when the bending angle θ is 90, the size of a side lobe can be significantly reduced, and the directivity of the antenna module M can be increased.

Please refer to FIG. 9 and FIG. 10 again. In this embodiment, the antenna module M also includes at least one support arm 301, for example, one support arm 301, two support arms 301, or three support arms 301, but the instant disclosure is not limited thereto. The quantity may be adjusted by users according to actual needs. Please refer to FIG. 9. FIG. 9 is an implementation pattern of one support arm 301 included in a first embodiment of the instant disclosure. The support arm 301 has a connecting end 3011 and a coating end 3012 opposite to the connecting end. Each of the connecting ends 3011 is fixedly connected to the periodic structure 200. The antenna 100 is coated on each of the coating ends 3012.

Please refer to FIG. 10 again, which is an implementation pattern of two support arms 301 included in a second embodiment of the instant disclosure. Each of the support arms 301 has a connecting end 3011 and a coating end 3012 opposite to the connecting end. The two connecting ends 3011 are fixedly connected to the periodic structure 200. The two coating ends 3012 are in contact with each other. The antenna 100 is coated on the two coating ends 3012.

### Third Embodiment

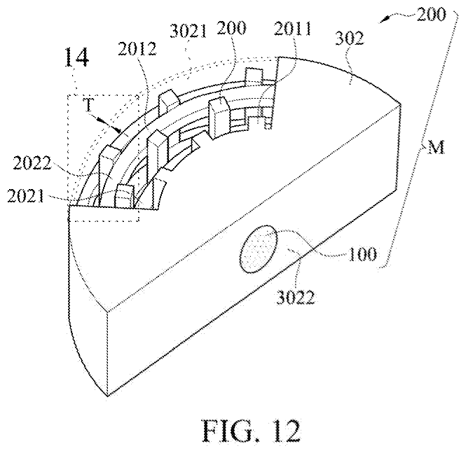

Please refer to FIG. 12. FIG. 12 is a schematic perspective view of one implementation pattern of a third embodiment of the instant disclosure. The similarities to the second embodiment in the present embodiment will be marked with the same component symbols, and the same components and structures will not be repeated. In the present embodiment, the periodic structure 200 and the antenna 100 are connected through a support housing 302.

Specifically, the support housing 302 houses the periodic structure 200. The antenna 100 is coated on the exposed surface 3022. The support housing 302 is manufactured by, not limited to, a ceramic manufacturing technology. The support housing 302 may also be a housing of an electronic device, such as a housing of a mobile phone. That is, the periodic structure 200 may be directly assembled into the mobile phone, and the antenna 100 may be coated on an outer surface of the housing of the mobile phone.

The support housing 302 has a fixed connection surface 3021 and an exposed surface 3022. The exposed surface 3022 is an outer surface of the support housing 302. The antenna 100 is coated on the exposed surface 3022. The fixed connection surface 3021 is an inner surface of the support housing 302. The fixed connection surface 3021 is in contact with an end of at least one first pillar 2011, an end of at least one second pillar 2012, an end of at least one first bridge member 2021, and an end of at least one second bridge member 2022. The fixed connection surface 3021 may also be in contact with two ends of at least one first pillar 2011, two ends of at least one second pillar 2012, two ends of at least one first bridge member 2021, and two ends of at least one second bridge member 2022.

However, the instant disclosure is not limited thereto, and may be designed according to actual needs. That is, the quantity of the pillars (for example, the first pillars 2011 and the second pillars 2012) or the bridge members (for example, the first bridge members 2021 and the second bridge members 2022) having one or two ends in contact with the fixed connection surface 3021 may be selectively designed. In addition, the periodic structure 200 does not have to be completely housed in the support housing 302, and may be partially housed in the support housing 302.

Please refer to FIG. 14. FIG. 14 is a partial view of part 14 in a second embodiment shown in FIG. 12. In the present embodiment, the support housing 302 has a thickness T. The preferred thickness T is related to the material of the periodic structure 200 and the frequency of the signal. The thickness T is calculated according to the following equation:

$$T \leq \frac{1}{N} \times \frac{C}{f \sqrt{{ɛ}_{r}}}$$

“T” represents a thickness of a housing, “C” represents a speed of light, “f” represents a frequency, and “εᵣ” represents a relative dielectric coefficient of a material. Preferably, “N” is a positive integer between 6 and 12.

### Fourth Embodiment

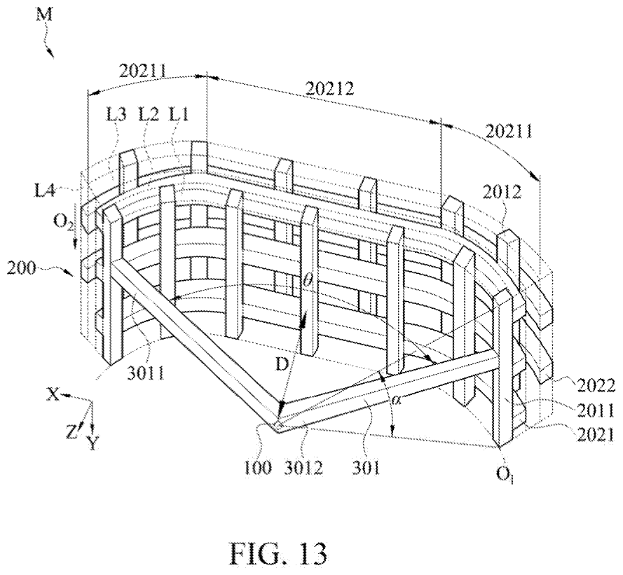

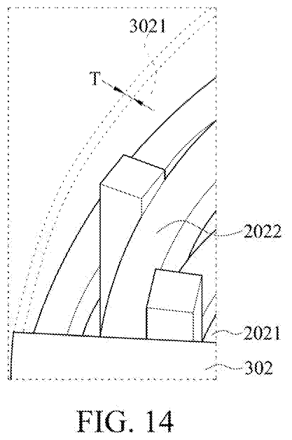

Please refer to FIG. 13. FIG. 13 is a schematic perspective view of one implementation pattern of a fourth embodiment of the instant disclosure. The similarities to the first embodiment and the second embodiment in the present embodiment will be marked with the same component symbols and will not be repeated.

In the present embodiment, the first pillars 2011 on left and right sides are arranged at intervals in the direction of a one-dimensional array O1 of an arc. The first pillars 2011 in the middle are arranged at intervals in the direction of a one-dimensional array O1 of a straight line. The first bridge members 2021 extend in an arrangement direction of the first pillars 2011. That is, each of the first bridge members 2021 in the present embodiment has a middle section 20212 and two arc-shaped portions 20211. The middle section 20212 is connected between the two arc-shaped portions 20211. The two arc-shaped portions 20211 have a corresponding bending angle θ respectively. The description of the bending angle θ refers to the second embodiment. The descriptions are omitted in this embodiment.

In the present embodiment, one support arm 301 or two support arms 301 described in the foregoing first embodiment and second embodiment may be used to connect the periodic structure 200 and the antenna 100. The support housing 302 described in the foregoing third embodiment may also be used to connect the periodic structure 200 and the antenna 100.

It should be noted that the periodic structure 200 and the support structure (the support arm 301 and the support housing 302) of the antenna module M according to the instant disclosure may be arbitrarily combined by the implementation pattern in the above example. For example, the antenna module M is not necessarily a combination including the first pillars 2011 arranged in a straight line at intervals and the support arm 301 as shown in the first embodiment. The support arm 301 may also be replaced with the support housing 302.

Based on the foregoing, in the instant disclosure, the design of returning electromagnetic waves by a unique periodic structure 200 and placing the antenna 100 at a location where the periodic structure 200 is three quarters of the wavelength of the transmitted signal effectively reduces the lateral and backward radiation (or diffraction) of the antenna module M, improves the directivity of the antenna module M, and improves the radiation efficiency of the antenna module M.

Although the instant disclosure has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An antenna module, comprising:
an antenna, configured to transmit or feed a signal; and
a periodic structure, disposed on one side of the antenna, and comprising:
a plurality of first pillars, arranged at intervals along a one-dimensional array;
a plurality of first bridge members, arranged at intervals along the one-dimensional array, and connected to a side of the first pillars away from the antenna, wherein the first bridge members define a second virtual layer; and
a plurality of second pillars, arranged at intervals in parallel with the plurality of first pillars and connected to a side of the first bridge members away from the antenna, wherein the plurality of second pillars define a third virtual layer, and wherein each of the second pillars and each of the first pillars adjacent thereto have an offset from each other in a direction perpendicular to the second virtual layer.

2. The antenna module according to claim 1, further comprising: a plurality of second bridge members, arranged at intervals along the one-dimensional array and connected to a side of the second pillars away from the antenna, wherein each of the second bridge members and each of the first bridge members adjacent thereto have an offset from each other in the direction perpendicular to the third virtual layer.

3. The antenna module according to claim 1, wherein the first pillars are parallel to each other, the first bridge members are parallel to each other, and the first pillars are perpendicular to the first bridge members.

4. The antenna module according to claim 1, wherein there is a distance between the antenna and the periodic structure, the distance being one half to four fifths of a wavelength of the signal.

5. The antenna module according to claim 1, wherein intervals between two adjacent first pillars are not exactly the same.

6. The antenna module according to claim 5, wherein the intervals are increased or decreased sequentially in an arrangement direction of the first pillars.

7. The antenna module according to claim 1, wherein each of the first bridge members is arc-shaped, and the first bridge member has a corresponding bending angle.

8. The antenna module according to claim 1, wherein each of the first bridge members has a middle section and two arc-shaped portions, the two arc-shaped portions have a corresponding bending angle respectively, and the middle section is connected between the two arc-shaped portions.

9. The antenna module according to claim 1, wherein the first pillars and the second pillars have similar volumes and shapes respectively.

10. The antenna module according to claim 1, further comprising: at least one support arm, wherein each of the support arms has a connecting end and a coating end opposite to the connecting end, each of the connecting ends is fixedly connected to the periodic structure, and the antenna is coated on each of the coating ends.

11. The antenna module according to claim 1, further comprising: two support arms, wherein each of the support arms has a connecting end and a coating end opposite to the connecting end, the two connecting ends are fixedly connected to the periodic structure, the two coating ends are in contact with each other, and the antenna is coated on the two coating ends.

12. The antenna module according to claim 1, further comprising: a support housing, wherein the support housing houses the periodic structure, the support housing has a fixed connection surface and an exposed surface, the fixed connection surface is in contact with an end of at least one of the first pillars, an end of at least one of the first bridge members, and an end of at least one of the second pillars, and the antenna is coated on the exposed surface.

13. The antenna module according to claim 1, wherein the support housing has a thickness that satisfies the following equation:
$$T \leq \frac{1}{N} \times \frac{C}{f \sqrt{{ɛ}_{r}}}$$
where “T” represents a thickness of a housing, “C” represents a speed of light, “f” represents a frequency, and “εᵣ” represents a relative dielectric coefficient of a material, “N” being a positive integer between 6 and 12.

14. An antenna module, comprising:
an antenna, configured to transmit or feed a signal; and
a periodic structure, disposed on one side of the antenna, and comprising:
a plurality of first bridge members, arranged at intervals along a one-dimensional array;
a plurality of first pillars, arranged at intervals along the one-dimensional array, and connected to a side of the first bridge members away from the antenna, wherein the first pillars define a second virtual layer; and
a plurality of second bridge members, arranged at intervals in parallel with the plurality of first bridge members and connected to a side of the first bridge members away from the antenna, wherein the plurality of second bridge members define a third virtual layer, and wherein each of the second bridge members and each of the first bridge members adjacent thereto have an offset from each other in a direction perpendicular to the second virtual layer.

15. The antenna module according to claim 14, wherein the first bridge members are parallel to each other, the first pillars are parallel to each other, and the first bridge members are perpendicular to the first pillars.

16. The antenna module according to claim 14, wherein intervals between two adjacent first pillars are not exactly the same, and the first pillars and the second pillars have similar volumes and shapes respectively.

17. The antenna module according to claim 14, wherein each of the first bridge members is arc-shaped, and the first bridge member has a bending angle corresponding to the first bridge member.

18. The antenna module according to claim 14, wherein each of the first bridge members has a middle section and two arc-shaped portions, the two arc-shaped portions have a corresponding bending angle respectively, and the middle section is connected between the two arc-shaped portions.

19. The antenna module according to claim 14, further comprising: at least one support arm, wherein each of the support arms has a connecting end and a coating end opposite to the connecting end, each of the connecting ends is fixedly connected to the periodic structure, and the antenna is coated on each of the coating ends.

20. The antenna module according to claim 14, further comprising: a support housing, wherein the support housing houses the periodic structure, the support housing has a fixed connection surface and an exposed surface, the fixed connection surface is in contact with an end of at least one of the first pillars, an end of at least one of the first bridge members and an end of at least one of the second pillars, wherein the antenna is coated on the exposed surface, and the support housing has a thickness that satisfies the following equation:
$$T \leq \frac{1}{N} \times \frac{C}{f \sqrt{{ɛ}_{r}}}$$
where “T” represents a thickness of a housing, “C” represents a speed of light, “f” represents a frequency, and “εᵣ” represents a relative dielectric coefficient of a material, “N” being a positive integer between 6 and 12.
